(19) United States
(12) Patent Application Publication
(10) Pub. No.: US 2021/0317673 A1
(43) Pub. Date: Oct. 14, 2021

(54) Surface Concealment System

(71) Applicant: Daniel Logan Daley, Fort Collins, CO (US)

(72) Inventor: Daniel Logan Daley, Fort Collins, CO (US)

(21) Appl. No.: 16/846,752

(22) Filed: Apr. 13, 2020

(51) Int. Cl. E04G 23/02; C09J 7/22; C09J 7/29; C09J 7/28; C09J 7/50; E04F 21/165

(52) U.S. Cl. CPC E04G 23/0214; C09J 7/22; C09J 7/29; C09J 2400/163; C09J 7/50; E04F 21/1657; C09J 7/28

(57) ABSTRACT

A multi-layered surface indentation concealment system including a plurality of superimposed layers. The plurality of superimposed layers can be disposed on a surface to span and conceal a surface indentation in the surface.

### I. FIELD OF THE INVENTION

A multi-layered surface indentation concealment system including a plurality of superimposed layers. The plurality of superimposed layers can be disposed serially on a surface to span and conceal a surface indentation in the surface.

### II. SUMMARY OF THE INVENTION

A broad object of the invention can be to provide multi-layered surface indentation concealment system including a plurality of superimposed layers which from an innermost layer to an outermost layer successively cover a greater width, and wherein the plurality of superimposed layers from said innermost layer to said outermost layer, include at least a first layer comprising an adhesive and a second layer comprising a flexible strip and can further include one or more of a third layer comprising a first overcoat, a fourth layer comprising a second overcoat, which can be overlaid by a primer or paint. The second layer comprising the flexible strip can be pre-selected to have sufficient rigidity to span a surface indentation rather than fill the surface indentation, and can be pre-selected to have a flexible strip thickness coordinated with a preselected viscosity of one or more of the first overcoat, the second overcoat, the primer or the paint whereby the first overcoat, the second overcoat, the primer or the paint, or combinations thereof outwardly taper from the flexible strip edges to fill the difference in height between the flexible strip and the surface having the surface indentation.

Another broad object of the invention can be to provide a method of using embodiments of a multi-layer surface indentation concealment system. The method can include one or more of: adhering a flexible strip to a surface to span a surface indention in the surface. In particular embodiments the method can further include applying an adhesive to the surface about the surface indention or applying the adhesive to the flexible strip. The method can further include pre-selecting the flexible strip thickness or rigidity to allow the flexible strip to span the surface indentation without filling the surface indentation. The method can further include applying a first overcoat over the flexible strip to fill the difference in height between the flexible strip and the surface, and in particular embodiments the method can further include pre-selecting the flexible strip thickness or the first overcoat viscosity, or combinations thereof, to in part or in whole, fill the difference in height between the flexible strip and the surface, wherein the first overcoat can taper between the flexible strip edges to the surface. The method can further include applying a second overcoat over the first overcoat to in part or in whole, fill the difference in height between the flexible strip and the surface, and in particular embodiments the method can further include pre-selecting the flexible strip thickness or the second overcoat viscosity, or combinations thereof, to fill the difference in height between the flexible strip and the surface, wherein the second overcoat can taper between the flexible strip edges to the surface. The method can further include applying a primer or paint over the flexible strip, the first overcoat, or the second overcoat, an in particular embodiments pre-selecting the flexible strip thickness or the viscosity of the primer or the paint, or combinations thereof, to fill the difference in height between the flexible strip and the surface.

Naturally, further objects of the invention are disclosed throughout other areas of the specification, drawings, photographs, and claims.

### III. A BRIEF DESCRIPTION OF THE DRAWINGS

FIG. 1 is an illustration of an embodiment of the multi-layered surface indentation concealment system applied to a surface to conceal a surface indentation.

FIG. 2 is a cross section view 2-2 shown in FIG. 1 depicting a method of serially applying the layers of the multi-layered surface indentation concealment system to a surface to conceal a surface indentation.

FIG. 3 is a top plan view of an embodiment of the multi-layered surface indentation concealment system.

FIG. 4 is a bottom plan view of an embodiment of the multi-layered surface indentation concealment system.

FIG. 5 is a cross section view 5-5 shown in FIG. 1 of the multi-layered surface indentation concealment system.

FIG. 6 is an enlarged portion of FIG. 5 of the multi-layered surface indentation concealment system.

FIG. 7 is a cross section view 7-7 shown in FIG. 1 depicting a method of superimposing a second layer comprising a flexible strip cut from a roll of flexible strip over a first layer comprising an adhesive applied to a surface and serially applying the third and fourth layers comprising first and second overcoats of the multi-layered surface indentation concealment system to a surface to conceal a surface indentation.

### IV. DETAILED DESCRIPTION OF THE PREFERRED EMBODIMENTS

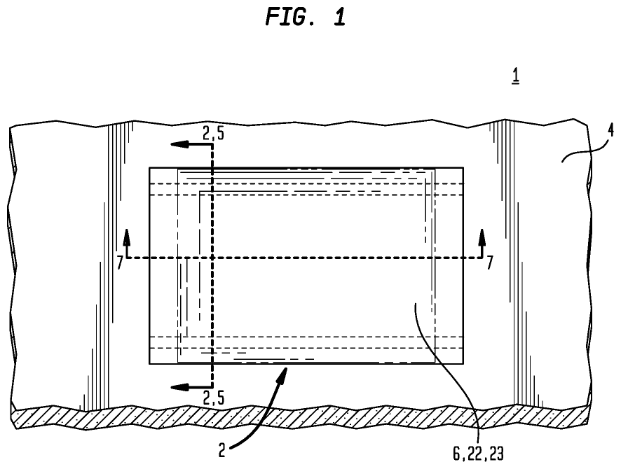

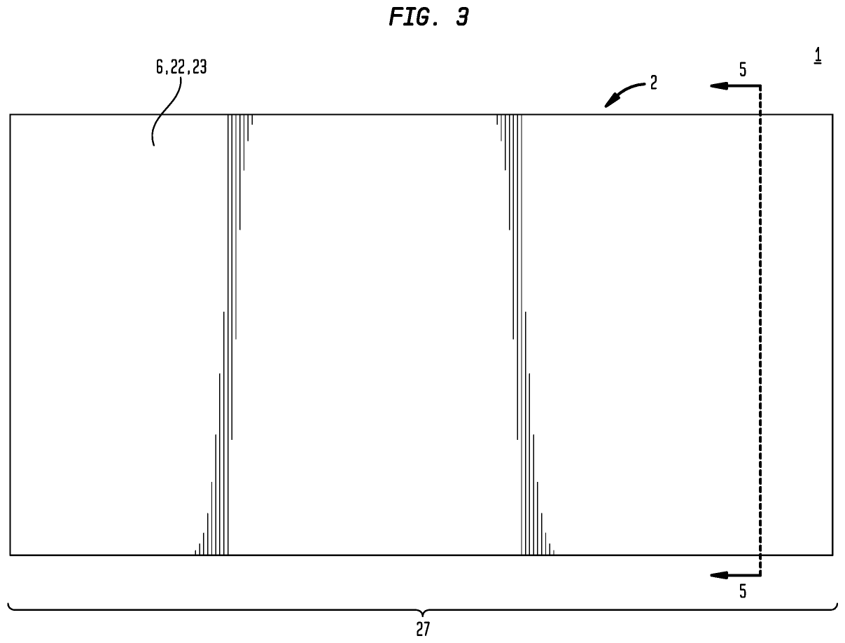

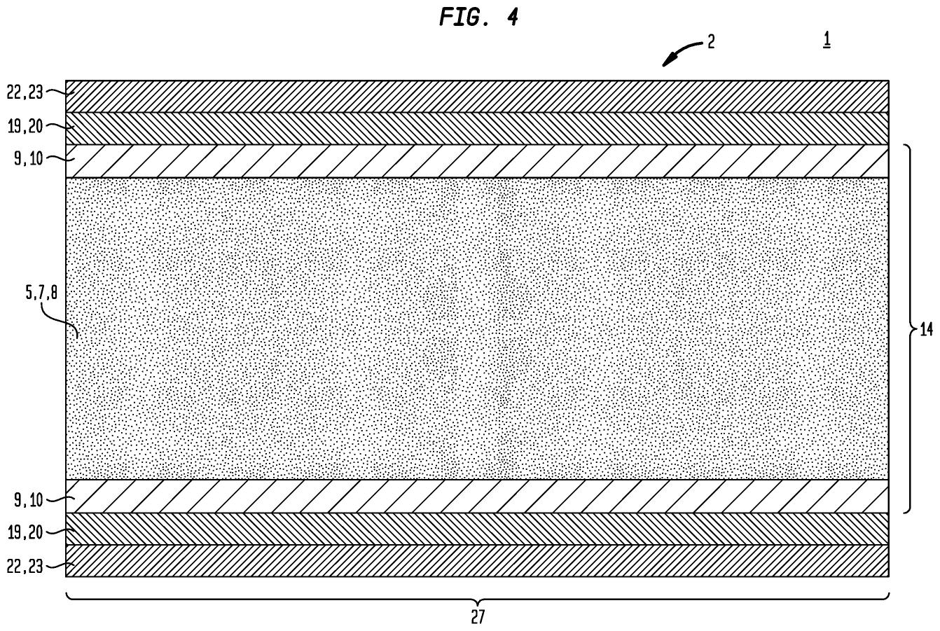

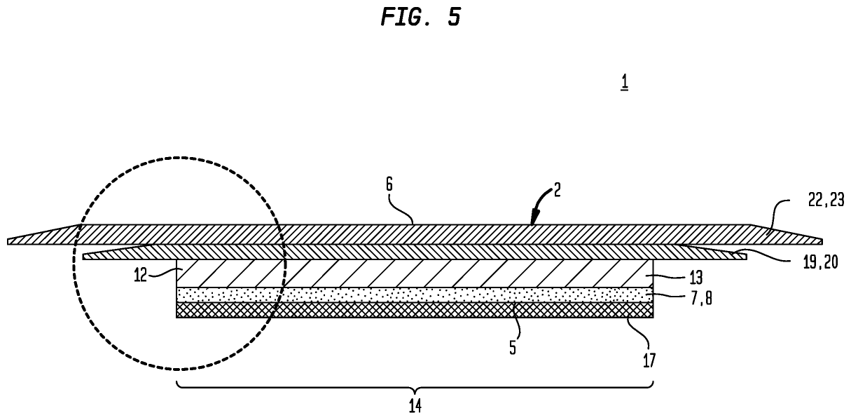

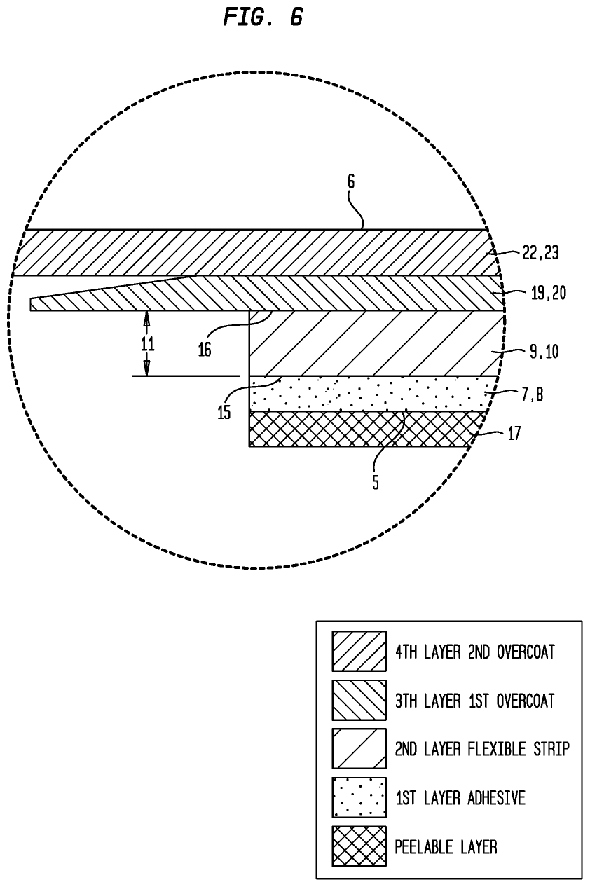

Generally, with reference to FIGS. 1 through 7, a multi-layered surface indentation concealment system (1) having a plurality of superimposed layers (2) which can be applied over a surface indentation (3) in a surface (4) and a method of applying the plurality of superimposed layers (2) over a surface indentation (3) in a surface (4). In particular embodiments, the plurality of superimposed layers (2) from an innermost layer (5) to an outermost layer (6) can, but need not necessarily, successively extend to a greater width. In particular embodiments, the plurality of superimposed layers (2) from the innermost layer (5) to the outermost layer (6), can comprise a first layer (7) comprising an adhesive (8) and a second layer (9) comprising a flexible strip (10).

The term “surface” for the purposes of this invention broadly encompasses the surface (4) of any material, and without limitation to the breadth of the forgoing illustrative examples of materials having surfaces (4) include drywall panels, plasterboard panels, gypsum board, sheetrock panels, wallboard, cement board, wood panels, plastic panels, fiber board, and combinations thereof.

The term “surface indentation” for the purposes of this invention means an irregularity which inwardly retreats from the face of a surface (4) or inwardly retreats between surfaces (4) and without limitation to the breadth of the foregoing, can as illustrative examples comprise a gap between affixed wall panels or drywall panels, holes penetrating a wall panel or drywall panel, or surface (4) gouges, indentations, recesses, hollows, pockets, pouches, apertures, pits, joints, seams, or the like.

The term “flexible strip” for the purposes of this invention broadly encompasses thin flat strips of flexible material and without limitation to the breadth of the foregoing in particular embodiments the flexible strips can comprise or consist of flexible plastic strips such as polyethylene terephthalate, polyester, polyethylene, polypropylene, polyvinylchloride, cellophane, regenerated cellulose, butyl acrylate, methyl acrylate, and methylmethacrylate or combinations thereof, and in other particular embodiments, the flexible strips can comprise or consist of flexible metal strips such as stainless steel, aluminum, copper, iron, zinc, steel, and combinations thereof. In particular applications, such as taping drywall there can be a substantial advantage to using a flexible strip comprised of stainless steel as opposed to conventional drywall tape because it has greater rigidity to cover over surface indentations without filling the surface indentation, irregularities, or space between panels with joint compound, and stainless steel does not appreciably shrink or crack and resists tarnishing and rust.

In particular embodiments, the second layer (9) comprising the flexible strip (10) can have a flexible strip thickness (11) occurring in a range of about 0.005 mm to about 0.10 mm. Depending on the application, the second layer (9) comprising the flexible strip (10) can have a flexible strip thickness (11) selected from the group comprising or consisting of: about 0.010 mm to about 0.020 mm, about 0.015 mm to about 0.025 mm, about 0.020 mm to about 0.030 mm, about 0.025 mm to about 0.035 mm, about 0.030 mm to about 0.040 mm, about 0.035 mm to about 0.045 mm, about 0.040 mm to about 0.050 mm, about 0.045 mm to about 0.055 mm, about 0.050 mm to about 0.060 mm, about 0.055 mm to about 0.065 mm, about 0.060 mm to about 0.070 mm, about 0.065 mm to about 0.075 mm, about 0.070 mm to about 0.080 mm, about 0.075 mm to about 0.085 mm, about 0.080 mm to about 0.090 mm, and about 0.085 mm to about 0.095 mm, and combinations thereof. In particular embodiments, the flexible strip (10) can, but need not necessarily, taper approaching one or more of the strip edges (12)(13); however, this is not intended to preclude the use of flexible strips (10) having substantially uniform flexible strip thickness (11) over the entirety of the flexible strip (10).

In particular embodiments, the second layer (9) comprising the flexible strip (10) can have a flexible strip width (14) between first and second flexible strip edges (12)(13). The flexible strip width (14) can occur in a range of about 25 mm to about 80 mm. In particular embodiments, the second layer (9) comprising the flexible strip (10) can have a flexible strip width (14) selected from the group consisting of: about 26 mm to about 35 mm, about 30 mm to about 40 mm, about 35 mm to about 45 mm, about 40 mm to about 50 mm, about 45 mm to about 55 mm, about 50 mm to about 60 mm, about 55 mm to about 65 mm, about 60 mm to about 70 mm, about 65 mm to about 75 mm, and about 70 mm to about 79 mm, and combinations thereof.

The term “adhesive” for the purposes of this invention broadly encompasses any substance which adheres to each of the flexible strip (10) and the surface (4) to spatially fix the flexible strip (10) on a surface (4). In particular embodiments, depending on the material of the flexible strip (10) and the material of the surface (4), the adhesive (8) can comprise or consist of: rubber cement, latex, butyl rubber, and combinations thereof. In particular embodiments, in which the surface (4) on which the plurality of superimposed layers (2) can be applied comprises or consists of drywall panels, plasterboard panels, gypsum board, sheetrock panels, wallboard, cement board, and combinations thereof, there can be a substantial advantage in an adhesive (8) comprising or consisting of ethyl 2-cyanoacrylate, polyvinylacetate, vinylacetate, aluminum chloride, 4,4′-methylenediphenyl diisocyanate, isocyanic acid, polymethylenepolyphenylene ester, methylenediphenyl diisocyanate, 2,4-dioxo-1,3-diazetidine-1,3-diylbis[p-phenylenemethylene-p-phenylene] diisocyanate, or combinations thereof. In particular embodiments, the adhesive (8) can comprise or consist of an aqueous emulsion of one or more of: polyvinyl acetate, polyvinyl alcohol, and propylene glycol, as illustrative examples: Elmer's Glue All, Part Number 69873 available from Elmer's Products, Inc. 460 Polaris Parkway, Suite 5, Westerville, Ohio 43082, or Titebond Quick & Thick Multisurface Glue, Part Number 2403 available from Franklin International, 2020 Bruck Street, Columbus, Ohio 43207.

In particular embodiments, the first layer comprising adhesive (8) can be disposed on or applied to a flexible strip first side (15). As to particular adhesives (8), the adhesive (8) can be applied to the flexible strip first side (15) by spray, or use of roller, brush, squeegee or the like. The adhesive (8) can have sufficient tack to adhere to a surface (4) under pressure applied to the flexible strip second side (16). As to these particular embodiments, a peelable layer (17) can, but need not necessarily, be peelably coupled to the first layer (7) comprising the adhesive (8). The peelable layer (17) can be peelably removed and the flexible strip (10) can be adhered to a surface (4) by contacting the first layer (7) comprising the adhesive (8) to the surface (4) under pressure applied to the flexible strip second side (16). The flexible strip (10) can remain affixed to the surface (4) to conceal the surface indentation (3). In other embodiments, in which the first layer (7) comprising the adhesive (8) does not comprise a pressure sensitive adhesive (8), the first layer (7) of the adhesive can be applied to the flexible strip first side (15) prior to engaging the first layer (7) comprising the adhesive (8) to the surface (4) and applying pressure to the flexible strip second side (16) until the flexible strip (10) becomes spatially fixed in relation to the surface (4). In other embodiments, in which the first layer (7) comprising the adhesive (8) does not comprise a pressure sensitive adhesive (8), the first layer of the adhesive (8) can be applied to the surface (4) prior to engaging the flexible strip first side (15) to the adhesive (8) and applying pressure to the flexible strip second side (16) unit the flexible strip (10) becomes spatially fixed in relation to the surface (4). The first layer comprising the adhesive (8), can but need not necessarily, extend to or outward of the opposing flexible strip edges (12)(13). A substantial advantage of embodiments of the invention, can be that the second layer (9) comprising the flexible strip (10) can be selected have sufficient amount of rigidity (18) to overlay the surface indentation (3) without filling the surface indentation (3) to support the flexible strip (10). This results in a substantial reduction in the time and materials to fill surface indentations (3) in a surface (4). As one illustrative example, in the example of a surface (4) comprising drywall panels, the drywall panels typically taper approaching the drywall panel edge, or the drywall edge can be prepared as further described below, and when abutted the taper results in a substantial surface indentation along with any gap remaining between the abutted drywall edges. Typically, a substantial amount of drywall joint compound would be applied over the surface indentation or drywall joint to fill the indentation and drywall tape would be applied over the drywall joint compound. A substantial advantage of particular embodiments of the invention can be that the second layer (9) comprising the flexible strip (10) can be adhered to the surface (4) of the drywall by the first layer (7) comprising the adhesive (8) over the surface indention (3) and the gap remaining between abutted drywall panel edges without the conventional use of drywall joint compound and without filling the surface indentation or the gap remaining between drywall panels because the material of the flexible strip (10) can afford sufficient rigidity to bride the surface indentation without having the flexible strip first side (15) being supported by any fill material.

Now with primary reference to FIGS. 1 through 7, particular embodiments of the plurality of superimposed layers (2) can, but need not necessarily, further comprise or consist of a third layer (19) comprising a first overcoat (20) applied over the flexible strip second side (16) opposite the flexible strip first side (15) superimposed by the first layer (7) comprising the adhesive (8) to the surface (4). The third layer (19) comprising the first overcoat (20) overlays or extends beyond the flexible strip edges (12)(13) to provide a taper in or fill by the first overcoat (20) which extends from the flexible strip second side (16) to the surface (4) engaged by the flexible strip (10). In particular embodiments, the third layer (19) comprising the first overcoat (20) can be selected from the group consisting of ethyl 2-cyanoacrylate, polyvinylacetate, vinylacetate, aluminum chloride, 4,4′-methylenediphenyl diisocyanate, isocyanic acid, polymethylenepolyphenylene ester, methylenediphenyl diisocyanate, 2,4-dioxo-1,3-diazetidine-1,3-diylbis[p-phenylenemethylene-p-phenylene] diisocyanate, latex, and combinations thereof. In particular embodiments, the first overcoat (20) can comprise or consist of the same composition as the first layer (7) comprising the adhesive (8), such as an aqueous emulsion of one or more of: polyvinyl acetate, polyvinyl alcohol, and propylene glycol. The viscosity (21) of the composition of the third layer (19) comprising the first overcoat (20) can be adjusted by increasing or decreasing the amount of solvent (whether organic or aqueous solvent) to resist flow away from the flexible strip edges (12)(13) and create the fill or taper between the flexible strip second side (16) and the surface (4) engaged by the flexible strip (10). Again, suitable materials for the third layer (19) comprising the first overcoat (20) can as illustrative examples include Elmer's Glue All, Part Number 69873 available from Elmer's Products, Inc. 460 Polaris Parkway, Suite 5, Westerville, Ohio 43082, or Titebond Quick & Thick Multisurface Glue, Part Number 2403 available from Franklin International, 2020 Bruck Street, Columbus, Ohio 43207. There can be a substantial advantage in having the third layer (19) comprising the first overcoat (20) be the same or substantially the same as the first layer (7) comprising the adhesive (8) in that substantially the same method of application can be used for both adhering and overcoating the flexible strip (10).

Again, with primary reference to FIGS. 1 through 7, in particular embodiments, the plurality of superimposed layers (2) can, but need not necessarily, further include a fourth layer (22) comprising a second overcoat (23) applied over the third layer (19) comprising the first overcoat (20). The fourth layer (22) comprising the second overcoat (23) overlays or extends beyond the first overcoat (20) and the flexible strip edges (12)(13) to further provide a taper in or fill by the second overcoat (23) which extends from the flexible strip second side (16) to the surface (4) engaged by the flexible strip (10). In particular embodiments, the fourth layer (22) comprising the second overcoat (23) can be selected from the group consisting of ethyl 2-cyanoacrylate, polyvinylacetate, vinylacetate, aluminum chloride, 4,4′-methylenediphenyl diisocyanate, isocyanic acid, polymethylenepolyphenylene ester, methylenediphenyl diisocyanate, 2,4-dioxo-1,3-diazetidine-1,3-diylbis[p-phenylenemethylene-p-phenylene] diisocyanate, and combinations thereof. In particular embodiments, the second overcoat (23) can comprise or consist of the same composition as the third layer (19) comprising the first overcoat (20) and the first layer (7) comprising the adhesive (8), such as an aqueous emulsion of one or more of: polyvinyl acetate, polyvinyl alcohol, and propylene glycol. The viscosity (21) of the composition of the fourth layer (22) comprising the second overcoat (23) can be adjusted by increasing or decreasing the amount of solvent (whether organic or aqueous solvent) to resist flow away from the flexible strip edges (12)(13) and create the fill or taper between the flexible strip second side (16) and the surface (4) engaged by the flexible strip (10). Again, suitable materials for the fourth layer (22) comprising the second overcoat (23) can as illustrative examples include Elmer's Glue All, Part Number 69873 available from Elmer's Products, Inc. 460 Polaris Parkway, Suite 5, Westerville, Ohio 43082, or Titebond Quick & Thick Multisurface Glue, Part Number 2403 available from Franklin International, 2020 Bruck Street, Columbus, Ohio 43207. There can be a substantial advantage in having the fourth layer (22) comprising the second overcoat (23) be the same or substantially the same as the third layer (19) comprising the first overcoat (20) and the first layer (7) comprising the adhesive (8) in that substantially the same method of application can be used for both adhering and overcoating the flexible strip (10). A second substantial advantage in using a first and second overcoat (20)(23) as described can be that if the first and second overcoat (20)(23) can have the respective coats smoothed before curing to a hardened layer, whether by brush, roller, squeegee, blade, sponge, or the like, and further efforts, if any, to smooth the first or second overcoat (20)(23) can be substantially reduced as compared to conventional sanding of cured joint compound to remove irregularities in conventional bedding of drywall which can be take substantial time and expense as compared to smoothing the first or second overcoats (20)(23) of the invention.

Again, with primary reference to FIGS. 1 through 7, the plurality of superimposed layers (2) can, but need not necessarily, further include a primer (24) to prepare the plurality of superimposed layers (2) and the surface (4) for paint (25). The primer (24) can, but need not necessarily, include any conventional primer to prepare surfaces for paint (24). Typically, the primer (24) includes about 20-30 percent synthetic resins (as examples, acrylic, vinyl, latex) about 60-80 percent solvents, and 2-5 percent additive agents. The primer (24) can ensure better adhesion of a paint (25) to the superimposed layers (2) and the surface (4).

In particular embodiments, the second layer (9) comprising the flexible strip (10) can be selected to have a flexible strip thickness (11) sufficiently thin for a primer (24) having a pre-selected viscosity (21) to be utilized as the third or fourth layers (19)(22) comprising the first or second overcoats (20)(23). As to these embodiments, the plurality of superimposed layers (2) omits the first and second overcoats (20)(23) and the primer (24) fills or tapers from the flexible strip second side (16) to the surface (4). In other embodiments, the primer (24) can be applied over the first or second overcoat (20)(23).

Again, with primary reference to FIGS. 1 through 7, embodiments can, but need not necessarily, include a paint layer (25) applied over the primer layer (24). The paint layer (25) can, but need not necessarily, be any conventional pigmented liquid, liquefiable, or solid mastic composition that after application to a surface (4) converts to a solid film. Typically, the paint layer (25) includes one or more of: a pigment, a binder, an extender, a solvent, and an additive as would be conventionally understood by one of skill in the art.

In particular embodiments, the second layer (9) comprising the flexible strip (10) can be pre-selected to have a flexible strip thickness (11) sufficiently thin and a paint (25) can be pre-selected to have a sufficient viscosity (21) to be utilized as the third or fourth layers (19)(22) comprising the first or second overcoats (20)(23) or the primer layer (24). As to these embodiments, the plurality of superimposed layers (2) omits the first or second overcoats (20)(23) or the primer layer (24) and fills or tapers from the flexible strip second side (16) to the surface (4) by application of the paint layer (25) over the flexible strip second side (16). In other embodiments, the paint layer (25) can be applied over the primer layer (24) and the first or second overcoats (20)(23).

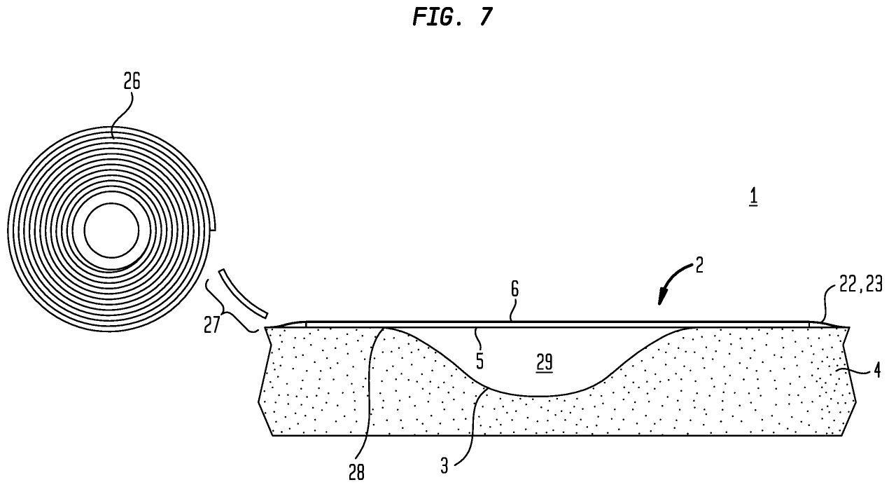

Now, with primary reference to FIG. 7, in particular embodiments, the plurality of superimposed layers (2), whether only the first and second layers (7)(9) comprising the adhesive (8) and the flexible strip (10) can be wound in a roll (26). The roll (26) can be unwound and a length (27) of the superimposed layers cut from the roll (26).

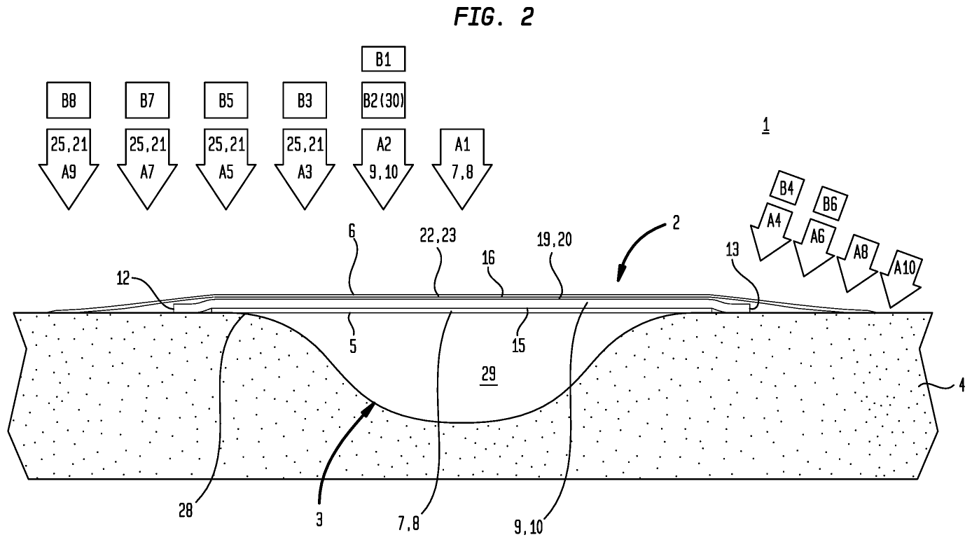

Now referring primarily to FIGS. 1 and 2, particular methods of using embodiments of the superimposed layers (2) can include serially disposing the superimposed layers (2) on a surface (4). The surface (4) can include a surface indentation (3) extending to a surface indentation rim (28).

Again, with primary reference to FIGS. 1 and 2, in particular methods of using embodiments, the superimposed layers (2) can be disposed over the surface indentation (3) with the innermost layer (5) disposed over the surface (94) around the surface indention rim (28). In particular methods, the superimposed layers (2) can span or bridge the surface indentation (3) with the outermost layer (6) secured about the surface indentation rim (28) defining the surface indentation (3). In this manner, the superimposed layers (2) span the unfilled space (29) but does not necessarily fill the unfilled space (29) of the surface indentation (3).

Now, with primary reference to FIG. 2, in particular embodiments, the method can further include serially applying the first layer (7) comprising the adhesive (8) to the surface (4) around the surface indentation (3) or the flexible strip first side (15)(Arrow A1) and subsequently engaging the second layer (9) comprising the flexible strip (10) to the surface (4) to cover the surface indentation (3)(Arrow A2). In particular embodiments, the method can further include pre-selecting the flexible strip thickness (11) or flexible strip rigidity (18) to allow the flexible strip (10) to span the surface indentation (3) without filling the unfilled space (29) (Block B1). The method can further include applying pressure (30) to the flexible strip second side (16) to affix the flexible strip (10) to the surface (4)(Block B2). Applying pressure (30) can be achieved using the hand or a tool such as a squeegee, roller, sponge, trowel, knife, scraper, or other like tool which can be contacted to and moved across the flexible strip second side (16).

Embodiments of the method can further include applying the third layer (19) comprising the first overcoat (20) over the second layer (9) comprising the flexible strip (10)(Arrow A3). In particular embodiments, the method can further comprise pre-selecting the flexible strip thickness (11) or pre-selecting the viscosity of the first overcoat (20)(Block B3) to allow the first overcoat to taper or fill in between the height of the flexible strip second side (16) and the height of the surface (4)(Arrow A4). Subsequent to applying the first overcoat (20), the method can further include smoothing the first overcome (20) to remove irregularities in the first overcoat (20)(Block B4). The first over coat (20) can be allowed cure to a hard layer.

Embodiments of the method can further include applying the fourth layer (22) comprising the second overcoat (23) over the third layer (19) comprising the first overcoat (20)(Arrow A5).

In particular embodiments, the method can further comprise pre-selecting the flexible strip thickness (11) or pre-selecting the viscosity (21) of the second overcoat (23)(Block B5) to allow the second overcoat (23) to taper or fill in between the height of the flexible strip second side (16) and the height of the surface (4) (Arrow A6). Subsequent to applying the second overcoat (23), the method can further include smoothing the second overcome (23) to remove irregularities in the second overcoat (20)(Block B6). The second over coat (23) can be allowed cure to a hard layer.

Embodiments of the method can further include applying a primer (24) over one of the second layer (9) comprising the flexible strip (10), the third layer (19) comprising the first overcoat (23), or the fourth layer (22) comprising the second overcoat (23)(Arrow A7). In particular embodiments, the method can further comprise pre-selecting the flexible strip thickness (11) or pre-selecting the viscosity (21)(Block B7) of the primer (24) to allow the primer (24) to taper or fill in between the height of the flexible strip second side (16) and the height of the surface (4), or fill irregularities in the first or second overcoat (20)(23) (Arrow A8). The primer (23) can be allowed cure to a hard layer.

Embodiments of the method can further include applying a paint (25) over one of the second layer (9) comprising the flexible strip (10), the third layer (19) comprising the first overcoat (23), the fourth layer (22) comprising the second overcoat (23), or the primer (24) (Arrow A9). In particular embodiments, the method can further comprise pre-selecting the flexible strip thickness (11) or pre-selecting the viscosity (21) of the paint (24) (Block B8) to allow the paint (24) to taper or fill in between the height of the flexible strip second side (16) and the height of the surface (4), or fill irregularities in the first or second overcoat (20)(23) or the primer (24)(Arrow A10). The paint (25) can be allowed cure to a hard layer.

### EXAMPLE. METHOD OF INSTALLING DRYWALL USING MULTI-LAYERED SURFACE INDENTATION CONCEALMENT SYSTEM TO CONCEAL DRYWALL SEAMS BETWEEN ABUTTED DRYWALL PANELS

A particular embodiment of the method of using the multi-layered surface indentation concealment system (1) to conceal drywall seams between abutted drywall panels, can comprise cutting and hanging drywall panels on wall studs. The method can include scoring through the paper layer on the first side of the drywall panel and breaking the drywall panel at the score line and subsequently cutting the paper layer on the second side of the drywall panel opposite the score line and detaching the respective portions of the dry wall panel. The method can further include removing features of the drywall panel at the score line raised above the cut drywall edge. The cut drywall edge may not be flat and residual tags of paper or dry wall core outwardly extending from the drywall edge can be removed using abrasive material have a course grit, a drywall rasp, or drywall sander, to achieve a substantially uniform flat drywall edge. Flat drywall edges can be disposed in abutted engagement on the stud wall. The method can further include removing features of the drywall edge outwardly extending in relation to the face of the first side of the drywall. In certain instances, the score through the paper layer on the first side of the dry wall panel can raise the edge of the paper layer along the score line which can be removed to allow the layers of the multi-layered surface indentation concealment system (1) to achieve a substantially flat outermost layer of the system on the drywall panel surface. The method can include running a cutting tool at a shallow angle along the score of the drywall edge to remove the protruding paper along the score line without penetrating the drywall core. The method can further include hanging the drywall panel on the stud wall. Abutted drywall panels will have a substantially reduced gap between abutted panels and compared with conventional methods of cutting and hanging drywall panels which omit removal of the features of the cut drywall edge raised outward of the score line. Embodiments of the multi-layered surface indentation concealment system (1) can subsequently applied to the drywall seams of abutted drywall panels to conceal drywall seams without the conventional use of drywall joint compound and drywall tape.

As can be easily understood from the foregoing, the basic concepts of the present invention may be embodied in a variety of ways. The invention involves numerous and varied embodiments of a multi-layered surface indentation concealment system and methods for making and using such multi-layered surface indentation concealment system including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “layer” should be understood to encompass disclosure of the act of “layering”—whether explicitly discussed or not—and, conversely, were there effectively disclosure of the act of “layering”, such a disclosure should be understood to encompass disclosure of a “layer” or even a “means for layering.” Such alternative terms for each element or step are to be understood to be explicitly included in the description.

In addition, as to each term used, it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the multi-layered surface indentation system herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1-25. (canceled)

26. A method, comprising:
disposing a plurality of superimposed layers on a surface, said plurality of superimposed layers from an inner layer to an outer layer, including:
a first layer comprising an adhesive; and
a second layer comprising a flexible strip.

27-28. (canceled)

29. The method of claim 26, further comprising applying said first layer of said adhesive to said surface.

30. The method of claim 29, further comprising applying said second layer comprising said flexible strip to said first layer comprising said adhesive.

31. The method of claim 26, wherein said adhesive is selected from the group consisting of ethyl 2-cyanoacrylate, polyvinylacetate, vinylacetate, aluminum chloride, 4,4′-methylenediphenyl diisocyanate, isocyanic acid, polymethylenepolyphenylene ester, methylenediphenyl diisocyanate, 2,4-dioxo-1,3-diazetidine-1,3-diylbis[p-phenylenemethylene-p-phenylene] diisocyanate, polyepoxides, rubber cement, latex, butyl rubber, and combinations thereof.

32. The method of claim 26, wherein said flexible strip comprises a flexible plastic strip.

33. The method of claim 32, wherein said flexible plastic strip is selected from the group consisting of polyethylene terephthalate, polyester, polyethylene, polypropylene, polyvinylchloride, cellophane, regenerated cellulose, or combinations thereof.

34. The system of claim 26, wherein said flexible strip comprises a flexible metal strip.

35. The system of claim 34, wherein said flexible strip is selected from the group consisting of: stainless steel, aluminum, copper, iron, zinc, steel, and combinations thereof.

36. The method of claim 26, further comprising applying a third layer comprising a first overcoat over said flexible strip second side, said flexible strip first side engaged to said surface.

37. The method of 36, wherein said first overcoat is selected from the group consisting of ethyl 2-cyanoacrylate, polyvinylacetate, vinylacetate, aluminum chloride, 4,4′-methylenediphenyl diisocyanate, isocyanic acid, polymethylenepolyphenylene ester, methylenediphenyl diisocyanate, 2,4-dioxo-1,3-diazetidine-1,3-diylbis[p-phenylenemethylene-p-phenylene] diisocyanate, polyepoxides, rubber cement, latex, butyl rubber, and combinations thereof.

38. The method of claim 36, further comprising applying a fourth layer comprising a second overcoat over said third layer comprising said first overcoat.

39. The method of 38, wherein said first overcoat is selected from the group consisting of ethyl 2-cyanoacrylate, polyvinylacetate, vinylacetate, aluminum chloride, 4,4′-methylenediphenyl diisocyanate, isocyanic acid, polymethylenepolyphenylene ester, methylenediphenyl diisocyanate, 2,4-dioxo-1,3-diazetidine-1,3-diylbis[p-phenylenemethylene-p-phenylene] diisocyanate, polyepoxides, rubber cement, latex, butyl rubber, and combinations thereof.

40. The method of claim 26, further comprising applying a primer layer over said second layer comprising said flexible strip.

41. The method of claim 40, further comprising applying a paint layer over said primer layer.

42. The method of claim 38, further comprising applying a primer layer over said third layer comprising said first overcoat or said fourth layer comprising said second overcoat.

43. The method of claim 42, further comprising applying a paint layer over said primer layer.

44. (canceled)

45. The method of claim 26, wherein said second layer comprising said flexible strip has a thickness occurring in a range of about 0.005 mm to about 0.10 mm.

46. The method of claim 45, wherein said second layer comprising said flexible strip has a thickness selected from the group consisting of: about 0.010 mm to about 0.020 mm, about 0.015 mm to about 0.025 mm, about 0.020 mm to about 0.030 mm, about 0.025 mm to about 0.035 mm, about 0.030 mm to about 0.040 mm, about 0.035 mm to about 0.045 mm, about 0.040 mm to about 0.050 mm, about 0.045 mm to about 0.055 mm, about 0.050 mm to about 0.060 mm, about 0.055 mm to about 0.065 mm, about 0.060 mm to about 0.070 mm, about 0.065 mm to about 0.075 mm, about 0.070 mm to about 0.080 mm, about 0.075 mm to about 0.085 mm, about 0.080 mm to about 0.090 mm, and about 0.085 mm to about 0.095 mm, and combinations thereof.

47. The method of claim 45, wherein said second layer comprising said flexible strip has a width occurring in a range of about 25 mm to about 80 mm.

48. The method of claim 47, wherein said second layer comprising said flexible strip has a width selected from the group consisting of: about 26 mm to about 35 mm, about 30 mm to about 40 mm, about 35 mm to about 45 mm, about 40 mm to about 50 mm, about 45 mm to about 55 mm, about 50 mm to about 60 mm, about 55 mm to about 65 mm, about 60 mm to about 70 mm, about 65 mm to about 75 mm, and about 70 mm to about 79 mm, and combinations thereof.

49-50. (canceled)
